(19) United States
(12) Patent Application Publication
(10) Pub. No.: US 2019/0270519 A1
(43) Pub. Date: Sep. 5, 2019

(54) DROP BOX AND UNMANNED AERIAL VEHICLE

(71) Applicant: SZ DJI TECHNOLOGY CO., LTD., Shenzhen (CN)

(72) Inventors: Li QIU, Shenzhen (CN); Jiuzhi SUN, Shenzhen (CN); Xumin WU, Shenzhen (CN)

(21) Appl. No.: 16/419,628

(22) Filed: May 22, 2019

Related U.S. Application Data
(63) Continuation of application No. PCT/CN2016/107365, filed on Nov. 25, 2016.

(51) Int. Cl. B64D 9/00; B65D 25/22; B63B 25/00; B64C 39/02

(52) U.S. Cl. CPC B64D 9/003; B65D 25/22; B64C 2201/128; B64C 39/024; B63B 25/004

(57) ABSTRACT

A drop box includes two cabinets each including an accommodating space and a bottom cabinet door below the accommodating space, and a locking member arranged at a bottom end of the two cabinets. The locking member is configured to be in a first, a second, and a third operation statuses. In the first operation status, the locking member contacts the bottom cabinet door of each of the two cabinets. In the second operation status, the locking member contacts the bottom cabinet door of one of the two cabinets and is separated from the bottom cabinet door of another one of the two cabinets. In the third operation status, the locking member is separated from the bottom cabinet door of each of the two cabinets.

### CROSS-REFERENCE TO RELATED APPLICATION

This application is a continuation application of International Application No. PCT/CN2016/107365, filed on Nov. 25, 2016, the entire content of which is incorporated herein by reference.

### TECHNICAL FIELD

The present disclosure relates to the field of unmanned aerial vehicle and, more particularly, to a drop box and an unmanned aerial vehicle.

### BACKGROUND

Natural disasters refer to natural phenomena that endanger human survivals or damage human living environments, including meteorological disasters such as droughts, floods, typhoons, hail, blizzards, sandstorms, etc.; geological disasters such as volcanoes, earthquakes, mountain collapses, landslides, and mudslides; marine disasters such as storm tides and seaquake; forest/grassland fires and major biological disasters; etc.

When a natural disaster occurs, people in the disaster area need timely and effective rescue. However, in the area where the natural disaster occurs, traffic conditions are often poor. Thus, in a conventional rescue method, it takes relatively long time for rescue personnels to reach on-site and perform rescue. As a result, emergency supplies cannot be delivered in a timely and effective manner, thereby reducing an efficiency and effectiveness of rescue.

### SUMMARY

In accordance with the disclosure, there is provided a drop box including two cabinets each including an accommodating space and a bottom cabinet door below the accommodating space, and a locking member arranged at a bottom end of the two cabinets. The locking member is configured to be in a first, a second, and a third operation statuses. In the first operation status, the locking member contacts the bottom cabinet door of each of the two cabinets. In the second operation status, the locking member contacts the bottom cabinet door of one of the two cabinets and is separated from the bottom cabinet door of another one of the two cabinets. In the third operation status, the locking member is separated from the bottom cabinet door of each of the two cabinets.

Also in accordance with the disclosure, there is provided an unmanned aerial vehicle (UAV) comprising: a fuselage; a controller arranged at the fuselage; and a drop box attached to the fuselage and coupled to the controller. The drop box includes two cabinets each including an accommodating space and a bottom cabinet door below the accommodating space, and a locking member arranged at a bottom end of the two cabinets. The locking member is configured to be in a first, a second, and a third operation statuses. In the first operation status, the locking member contacts the bottom cabinet door of each of the two cabinets. In the second operation status, the locking member contacts the bottom cabinet door of one of the two cabinets and is separated from the bottom cabinet door of another one of the two cabinets. In the third operation status, the locking member is separated from the bottom cabinet door of each of the two cabinets

### BRIEF DESCRIPTION OF THE DRAWINGS

FIG. 1 is a schematic bottom view of an example drop box consistent with various disclosed embodiments of the present disclosure.

FIG. 2 is another schematic bottom view of the example drop box consistent with various disclosed embodiments of the present disclosure.

FIG. 3 is another schematic bottom view of the example drop box consistent with various disclosed embodiments of the present disclosure.

FIG. 4 is an exploded view of an example locking member consistent with various disclosed embodiments of the present disclosure.

FIG. 5 is an assembled structural diagram of the example locking member consistent with various disclosed embodiments of the present disclosure.

FIG. 6 is a schematic view showing an example operation status of the example drop box consistent with various disclosed embodiments of the present disclosure.

FIG. 7 is an enlarged view of a portion A in FIG. 6 consistent with various disclosed embodiments of the present disclosure.

FIG. 8 is a schematic structural diagram of an example unmanned aerial vehicle consistent with various disclosed embodiments of the present disclosure.

FIG. 9 is another schematic structural diagram of the example unmanned aerial vehicle consistent with various disclosed embodiments of the present disclosure.

FIG. 10 is another schematic structural diagram of the example unmanned aerial vehicle consistent with various disclosed embodiments of the present disclosure.

FIG. 11 is an enlarged view of portion B in FIG. 10 consistent with various disclosed embodiments of the present disclosure.

FIG. 12 is a block diagram of an electronic control of the example unmanned aerial vehicle consistent with various disclosed embodiments of the present disclosure.

Reference numerals used in the drawings include: 1, cabinet; 11, bottom cabinet door; 12, side cabinet door; 2, locking member; 21, driving member; 211, steering gear; 212, steering gear fixing seat; 213, rotating shaft; 2131, coupling part; 2132, abutting part; 2133, guiding part; 214, first sheet body; 215, second sheet body; 216, first sliding member; 217, second sliding member; 218, protrusion; 22, reset member; 221, cushion; 222, restoring spring; 223, end cap; 3, first cabinet; 4, second cabinet; 5, fastener; 10, unmanned aerial vehicle (UAV); 101, fuselage; 102, power supply battery; and 103, controller.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. In the present disclosure, the terms “mounting,” “connecting,” “fixing,” or similar expressions should be broadly understood. For example, “connecting” may indicate a secure connection, a detachable connection, or an integral connection. The terms “perpendicular,” “horizontal,” “left,” “right,” and similar expressions used herein are merely intended for description.

It should be noted that in the description of the present disclosure, the terms “first” and “second” are used merely to describe different components, and are not to be construed as indicating or implying a sequence relationship, relative importance, or implicit indication of the number of technical features. Thus, a feature accompanied by “first” or “second” may include at least one of the feature, either explicitly or implicitly.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Further, in the present disclosure, the disclosed embodiments and the features of the disclosed embodiments may be combined when there are no conflicts.

The present disclosure provides an apparatus that can improve the efficiency of the rescue and ensure the performance of the rescue.

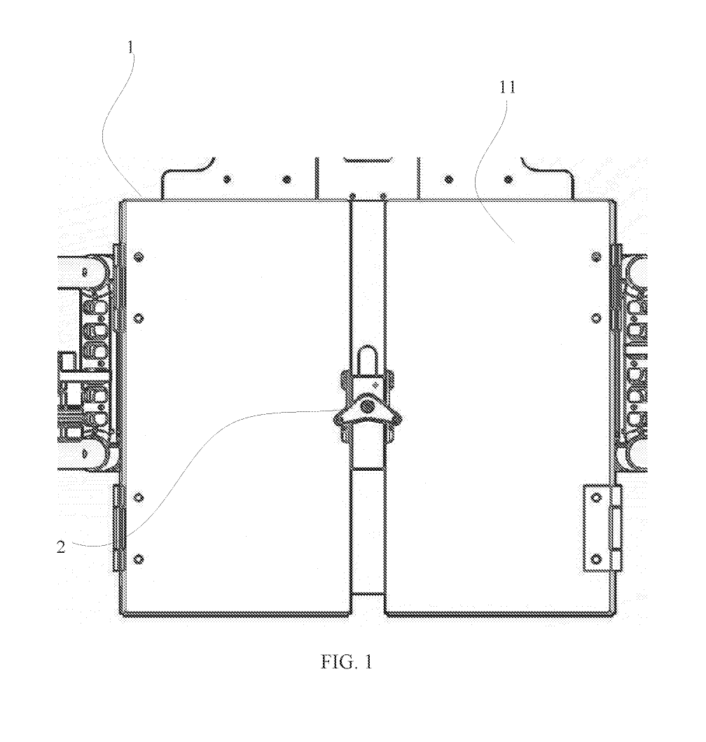

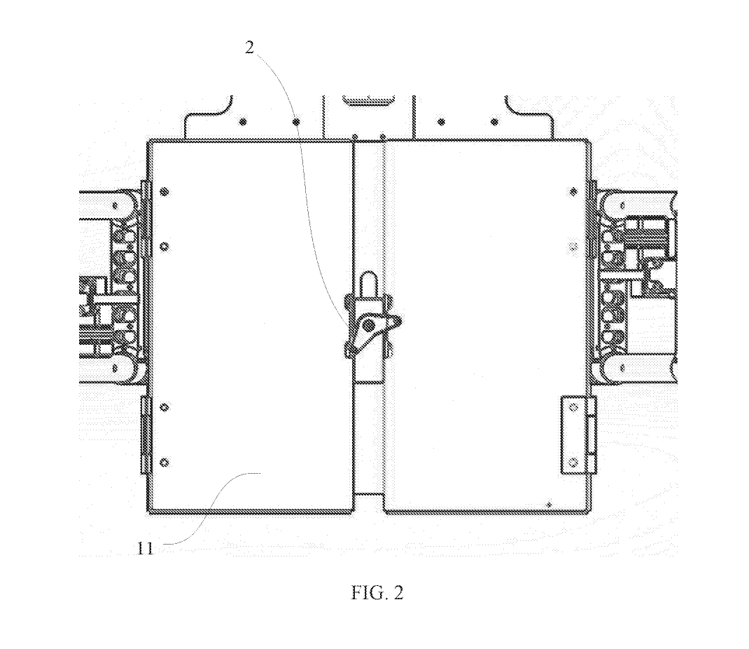

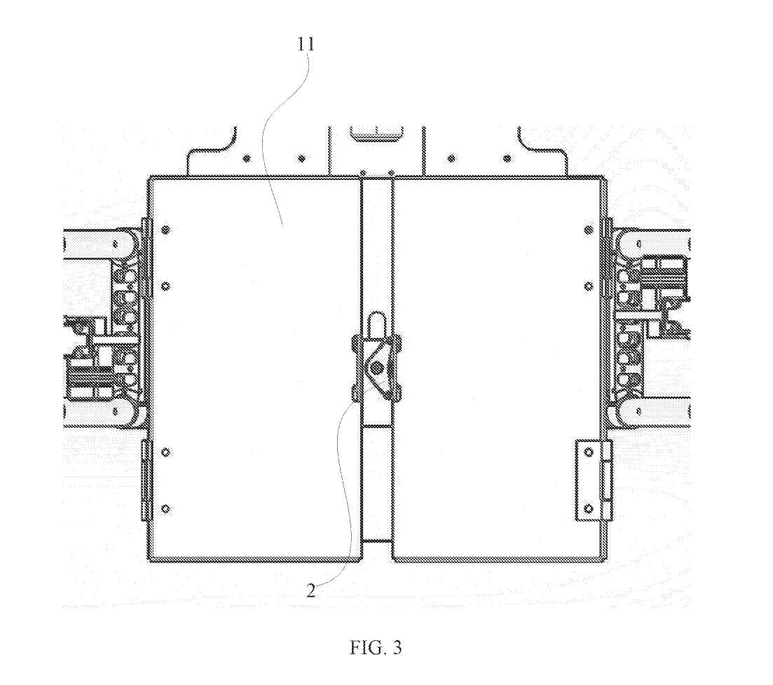

FIG. 1 is a schematic bottom view of an example drop box consistent with various disclosed embodiments of the present disclosure. FIG. 2 is another schematic bottom view of the example drop box consistent with various disclosed embodiments of the present disclosure. FIG. 3 is another schematic bottom view of the example drop box consistent with various disclosed embodiments of the present disclosure. As shown FIGS. 1 to 3, the present disclosure provides a drop box for accommodating objects that need to be delivered, e.g., dropped. The objects may include emergency supplies. Further, the drop box can be carried by an aerial vehicle. The aerial vehicle may include an unmanned aerial vehicle (UAV), an agricultural plant protection machine, and/or the like. In some embodiments, the drop box includes at least two cabinets 1. The cabinets 1 each include an accommodating space for accommodating objects. The cabinets 1 each include a bottom cabinet door 11 at a bottom of the accommodating space.

The drop box further includes a locking member 2 arranged at a bottom end of the at least two cabinets 1 for contacting with or separating from at least two bottom cabinet doors 11.

By adjusting an operation status of the locking member 2, the at least two bottom cabinet doors 11 may be opened sequentially.

When the locking member 2 is at a first operation status, the locking member 2 may be in contact with the at least two bottom cabinet doors 11, and the accommodating spaces at upper ends of, e.g., above, the bottom cabinet doors 11 may be at a closed status.

When the locking member 2 is at a second operation status, the locking member 2 may be separated from one bottom cabinet door 11, and the accommodating space at an upper end of, e.g., above, the bottom cabinet door 11 may be at an open status for releasing, e.g., dropping, objects placed in the accommodating space.

When the locking member 2 is at a third operation status, the locking member 2 may be separated from the at least two bottom cabinet doors 11, and the accommodating spaces at upper ends of, e.g., above, the at least two bottom cabinet doors 11 may be at an open status for releasing, e.g., dropping, the objects placed in the accommodating spaces.

In the present disclosure, the number of the cabinets 1 is not restricted, and may be chosen by those skilled in the art according to various application scenarios. For example, the number of the cabinets 1 can be set to two, three, four, five, etc. In some embodiments, each cabinet 1 includes an accommodating space for accommodating objects. Thus, the number of accommodating spaces may increase as the number of cabinets 1 increase. Correspondingly, a volume of the drop box may increase. In some embodiments, for example, the number of cabinets 1 can be set to two. Correspondingly, while the number of objects that can be accommodated in the drop box can be ensured, the space occupied by the drop box may be relatively small, thereby making it relatively convenient to use the drop box.

In the present disclosure, shape and structure, e.g., a shape, of the cabinet 1 are not restricted, and may be chosen by those skilled in the art according to various application scenarios. For example, the cabinet 1 can be set as having a rectangular structure or a square structure, as long as the cabinet 1 can include the accommodating space. The accommodating space may be used to accommodate objects that need to be dropped, for facilitating a movement operation of the objects.

In some embodiments, shape and structure of the locking member 2 are not restricted, and may be chosen by those skilled in the art according to various application scenarios, as long as the locking member 2 can be arranged at bottom ends of at least two cabinets and can be in contact with or separated from the bottom cabinet doors 11. The structure of the locking member 2 to achieve contacting with or separation from the bottom cabinet doors 11 is not restricted, and may be chosen by those skilled in the art according to various application scenarios, e.g., performance to achieve. For example, the locking member 2 can be in contact with or separated from the bottom cabinet doors 11 by means of a rotation, a sliding, a horizontal movement, etc. When the locking member 2 is in contact with or separated from the bottom cabinet doors 11 by means of a sliding, the locking member 2 may be attached to a sliding drive member. The sliding drive member may include a sliding lead screw, and the locking member 2 may be driven by the sliding lead screw to slide, thereby performing the operation to cause the locking member 2 to be in contact with or separated from the bottom cabinet doors 11. Those skilled in the art can also use other means to realize the contact with or separation from the bottom cabinet 11 by the locking member 2, descriptions of which are omitted here.

In some embodiments, the operation status of the locking member 2 may include a first operation status, a second operation status, or a third operation status. When the locking member 2 is at different operation statuses, the drop box may correspondingly be at different usage statuses. For example, when it is needed to arrange objects in the accommodating space of the drop box, or when it is needed to transfer or drop objects that have already been arranged, the drop box may be at different usage statuses. When the drop box is at a usage status of transferring the objects, it is needed to ensure safety and reliability of arrangement of the objects in the drop box. Correspondingly, it may be needed to control the accommodating space of the drop box to be in the closed status. Thus, the locking member 2 may be controlled to be at the first operation status, and the locking member 2 may be in contact with at least two bottom cabinet doors 11 of the drop box, thereby ensuring that the objects can be stably arranged in the corresponding accommodating space.

As the transfer operation on the objects are completed together with the transfer of the drop box, drop operation may need to be performed on the objects in the drop box. Further, when the objects are being dropped, objects in the at least two cabinets 1 may be successively dropped, in order to increase a drop region of the objects. In some embodiments, the objects in one accommodating space may be dropped first. Correspondingly, one accommodating space of the at least two cabinets 1, e.g., one accommodating space of one of the at least two cabinets 1, may need to be at an open status for dropping objects in that accommodating space. In some embodiments, the locking member 2 may be controlled to be at a second operation status. That is, the locking member 2 may be separated from the bottom cabinet door 11 for the accommodating space that is to be opened, thereby realizing a drop operation on the objects in one accommodating space.

Further, when objects in one accommodating space in the at least two cabinets 1, e.g., one accommodating space in one cabinet of the at least two cabinets 1, have been dropped or are being dropped, drop operations may be performed on objects in other accommodating space. Correspondingly, the accommodating spaces of the at least two cabinets 1 may need to be at an open status. Thus, the locking member 2 may need to be controlled to be at the third operation status. That is, the locking member 2 may be separated from the bottom cabinet doors 11 of at least two accommodating spaces, thereby realizing the drop operations on objects of other accommodating spaces sequentially and ensuring practicality of the drop box.

In some embodiments, the operation status of the locking member 2 is not limited to the above-mentioned first operation status, second operation status, and third operation status. For example, the operation status of the locking member 2 can also be configured to include a fourth operation status. When the locking member 2 is at the fourth operation status, the locking member 2 may be returned to the initial operation status, the locking member 2 may be separated from the at least two bottom cabinet doors 11, and correspondingly the accommodating spaces may be opened. That is, after the objects in the accommodating spaces are dropped, the locking member 2 may be returned to the initial position, and correspondingly the accommodating spaces may remain at the open status. Those skilled in the art can configure the operation status of the locking member 2 according to various application scenarios, descriptions of which are omitted here.

In the drop box of the present disclosure, by configuring at least two cabinets 1 and a locking member 2, the number of objects accommodated in the drop box may be ensured for a transfer operation of the objects. Correspondingly, the operation status of the locking member 2 may be adjusted to open at least two bottom cabinet doors 11 sequentially, thereby dropping the objects stored in the accommodating spaces sequentially. Accordingly, timely and effective delivery of the objects to corresponding locations may be achieved, quality and efficiency of first aid may be ensured, and thus the practicability of the drop box may be improved, which may be relatively beneficial to market promotions and applications.

Referring to FIGS. 1 to 3, in the present disclosure, the manner of sequentially opening the at least two bottom cabinet doors 11 by adjusting the operation status of the locking member 2 is not restricted. In some embodiments, the locking member 2 may be configured to be moved according to provided power to achieve the adjustment of the operation status of the locking member 2. The locking member 2 can be switched among at least three positions. When the locking member 2 is moved to a first position, the locking member 2 may be at a first operation status, and the at least two bottom cabinet doors 11 both may be at a closed status. When the locking member 2 is moved to a second position, the locking member 2 may be at a second operation status, and one of the at least two bottom cabinet doors 11 may be at an open status, and the other of the at least two bottom cabinet doors 11 may be at a closed status. When the locking member 2 is moved to a third position, the locking member 2 may be at a third operation status, and at least two bottom cabinet doors 11 each may be at an open status.

In some embodiments, the movement manner of the locking member 2 may be related to the provided power mode. For example, the movement manner of the locking member 2 may be configured to include a rotation mode, a sliding mode, or the like. In some embodiments, the locking member 2 may be configured to switch among at least three positions by means of rotation, e.g., in a rotation mode. Correspondingly, the rotation mode achieved by the locking member 2 can be realized by the power provided by a motor. Those skilled in the art can also adopt other methods to cause the locking member 2 to perform a rotation operation, description of which are omitted here.

In some embodiments, positions among which the locking member 2 can be switched are not restricted, and may be chosen by those skilled in the art according to various application scenarios. For example, adjacent positions of the three positions of the locking member 2 may form intersection angles of approximately 120°. That is, the three positions are sequentially set as an approximately 0° position, an approximately 120° position, and an approximately 240° position to which the locking member 2 may be rotated. Correspondingly, in order to achieve sequentially opening the at least two bottom cabinet doors 11 through the adjustment of the locking member 2, sizes of the at least two cabinets may be different from each other. Further, in order to improve the aesthetic appearance of the drop box, in some embodiments, the three positions of the locking member 2 may be set to positions of approximately 0°, approximately 45°, and approximately 90° to which the locking member 2 may be rotated. Correspondingly, sizes of the at least two cabinets can be same. Thus, design of the locking member 2 and the cabinets 1 may be relatively convenient for a designer, difficulty of production and processing may be reduced, and control of the drop operation of the drop box may be relatively convenient. In some embodiments, referring to FIG. 1, when the locking member 2 is rotated to a position of approximately 0°, the locking member 2 may contact at least two bottom cabinet doors 11, and thus ensure safety and reliability of the objects arranged in the accommodating space. Referring to FIG. 2, when the locking member 2 is rotated to a position of approximately 45°, the locking member 2 may be separated from at least one bottom cabinet door 11, such that one accommodating space of the at least two cabinets 1 may be at an open status, and objects in the accommodating space may be dropped. Referring to FIG. 3, when the locking member 2 is rotated to a position of approximately 90°, the locking member 2 may be separated from the at least two bottom cabinet doors 11. Correspondingly, accommodating spaces in the at least two cabinets 1 each may be at an open status, and drop operations may be performed on all objects in the accommodating spaces, thereby achieving sequential drop operations of the objects and ensuring stability and reliability of the drop box.

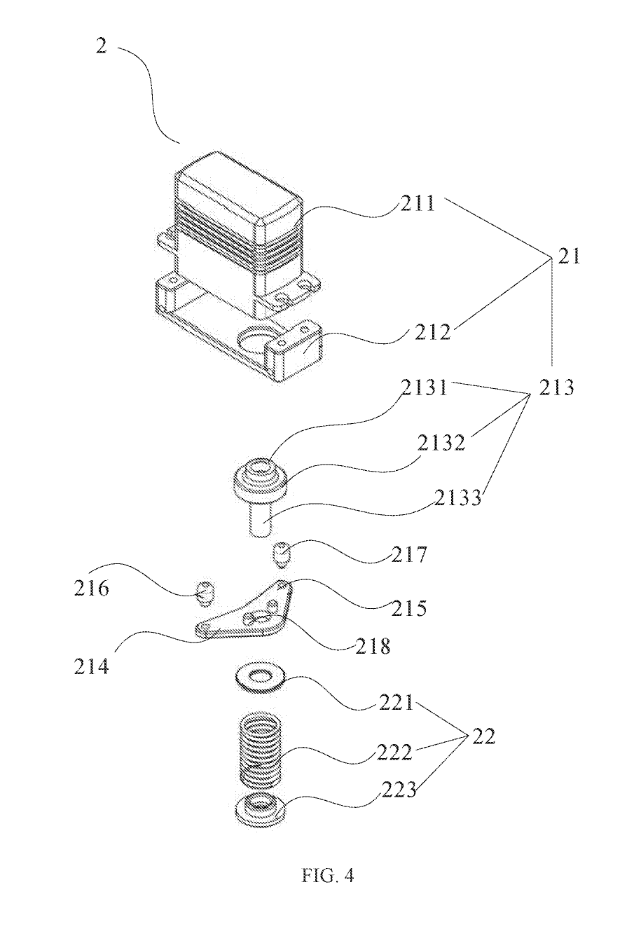

FIG. 4 is an exploded view of an example locking member 2 consistent with various disclosed embodiments of the present disclosure. FIG. 5 is an assembled structural diagram of an example locking member 2 consistent with various disclosed embodiments of the present disclosure. In addition to the above-described examples, referring to FIGS. 1 to 5, in some embodiments, the shape and structure of the locking member 2 are not restricted and may be chosen by those skilled in the art according to various application scenarios. In some embodiments, the locking member 2 may be configured to include a first sheet body 214 and a second sheet body 215. A preset intersection angle may exist between the first sheet body 214 and the second sheet body 215.

The first sheet body 214 and the second sheet body 215 may be used to realize contacting with or separation from the bottom cabinet doors 11, such that the locking member 2 may be switched among at least three positions. In the present disclosure, structure shapes of the first sheet body 214 and the second sheet body 215 are not restricted and may be chosen by those skilled in the art according to various application scenarios. For example, the first sheet body 214 and the second sheet body 215 can be arranged in a stripe or square structure. As another example, the first sheet body 214 and the second sheet body 215 may be arranged in similar triangular structures. In addition, the first sheet body 214 and the second sheet body 215 may be coupled to each other and form a preset intersection angle. A magnitude of the intersection angle between the first sheet body 214 and the second sheet body 215 is not restricted. For example, the intersection angle may be set at an angle of approximately 120°, an angle of approximately 150°, or other angles, as long as the first sheet body 214 and the second sheet body 215 can cause the locking member 2 to be switched among at least three positions, descriptions of which are omitted here.

In order to achieve the contact or separation operations of the first sheet body 214 and the second sheet body 215 with respect to the bottom cabinet doors 11, the locking member 2 may be configured to further include a first sliding member 216 and a second sliding member 217. The first sliding member 216 may be vertically arranged at an end of the first sheet body 214, and the second sliding member 217 may be vertically arranged at an end of the second sheet body 215. Limiting slots may be arranged at the at least two bottom cabinet doors 11. As the locking member 2 is switched in the at least three positions, the first sliding member 216 and the second sliding member 217 may be used to slide in corresponding limiting slots.

In some embodiments, the end of the first sheet body 214 may be an end of the first sheet body 214 away from the second sheet body 215, and the end of the second sheet body 215 may be an end of the second sheet body 215 away from the first sheet body 214. Further, shapes and structures of the first sliding member 216 arranged at the end of the first sheet body 214 and the second sliding member 217 arranged at the end of the second sheet body 215 are not restricted, and may be chosen by those skilled in the art according to various application scenarios. For example, the first sliding member 216 and the second sliding member 217 can be configured to include a cylindrical structure, a bar structure, a triangular pyramid structure, or the like. In some embodiments, the first sliding member 216 and the second sliding member 217 can be configured to each include a cylindrical structure. Further, in order to improve smoothness of the first sliding member 216 and the second sliding member 217 in the limiting slots, ends of the cylindrical structure may be configured to include relatively smooth elliptical structure to facilitate the slide operations of the first sliding member 216 and the second sliding member 217 in the limiting slots.

In addition, shapes and structures of the limiting slots are not restricted, and may be chosen by those skilled in the art according to rotation paths of the first sheet body 214 and the second sheet body 215. For example, the limiting slots may include a circular arc shape, a fan-shaped structure, or the like. In some embodiments, in order to achieve sliding of the first sliding member 216 and the second sliding member 217 in the limiting slots, inner diameters of the limiting slots may be larger than outer diameters of the first sliding member 216 and the second sliding member 217.

By arranging the first sheet body 214 and the second sheet body 215 and setting the first sheet body 214 and the second sheet body 215 with a preset angle therebetween, the locking member 2 may be switched among at least three positions through rotations of the first sheet body 214 and the second sheet body 215. In some embodiments, the first sliding member 216 and the second sliding member 217 may slide in the limiting slots, such that switching in operation statuses of the locking member 2 may be ensured, and stability and reliability of the drop box for performing the drop operations may be improved.

Referring to FIGS. 1-5, in some embodiments, the drop box further includes a driving member 21.

The driving member 21 is configured to provide power for the locking member 2. The driving member 21 is coupled to the locking member 2 to cause the locking member 2 to switch sequentially to the first operation status, the second operation status, and the third operation status.

In the present disclosure, the shape and structure of the driving member 21 are not restricted, and may be chosen by those skilled in the art according to functions of the driving member 21. For example, the driving member 21 can be set as a driving motor, a screw, or the like. In some embodiments, the driving member 21 includes a steering gear 211 and a rotating shaft 213 coupled to the steering gear 211. The steering gear 211 may cause the locking member 2 to rotate through the rotating shaft 213.

In the present disclosure, the implementation process of the steering gear 211 causing the locking member 2 to rotate through the rotating shaft 213 is not restricted, and may be chosen by those skilled in the art according to various application scenarios. For example, the locking member 2 may be arranged at an outer side of the rotating shaft 213, e.g., arranged on the outer side of the rotating shaft 213 as a sleeve, and securely attached to the rotating shaft 213, to ensure that the locking member 2 may be rotated together with a rotation of the rotating shaft 213. Correspondingly, in order to ensure rotation stability and reliability of the locking member 2, in some embodiments, the rotating shaft 213 may be configured to include a coupling part 2131 and an abutting part 2132. The coupling part 2131 may be coupled to an output end of the steering gear 211. The abutting part 2132 may be coupled to the locking member 2 in a transmission connection. When the rotating shaft 213 is driven by the steering gear 211 to rotate, the abutting part 2132 may cause the locking member 2 to rotate.

Further, in order to improve efficiency of the coupling between the locking member 2 and the rotating shaft 213, the rotating shaft 213 may further include a guiding part 2133 coupled to the abutting part 2132. The coupling part 2131 and the guiding part 2133 may be arranged above and below the abutting part 2132, respectively. For example, the coupling part 2131 may be arranged at a top side of the abutting part 2132, and the guiding part 2133 may be arranged at a bottom side of the abutting part 2132.

In some embodiments, the shape and structure of the portion 2133 are not restricted, and may be chosen by those skilled in the art according to various application scenarios. In some embodiments, the guiding part 2133 may include a cylindrical structure. The guiding part 2133 may have a smaller outer diameter than the abutting part 2132, such that the efficiency of the coupling between the locking member 2 and the rotating shaft 213 may be improved through the guiding of the guiding part 2133, when the locking member 2 and the rotating shaft 213 are being coupled to each other. Accordingly, installation time cost of the drop box may be reduced, and ease of use of the drop box may be improved.

In addition, the shapes and structures of the coupling part 2131 and the abutting part 2132 are not restricted, and may be chosen by those skilled in the art according to various application scenarios. In order to facilitate coupling between the coupling part 2131 and the output end of the steering gear 211, in some embodiments, the coupling part 2131 may include an annular structure, e.g., a circular ring structure. Correspondingly, the output end of the steering gear 211 may be arranged inside the annular structure. In some embodiments, the abutting part 2132 may be securely attached to the coupling part 2131, and may be coupled to the lock member 2 in a transmission connection. Thus, in order to ensure the stability and reliability of the transmission connection between the abutting part 2132 and the locking member 2, the abutting part 2132 may be arranged, as a sleeve, at an outside of the coupling part 2131. Accordingly, the size of the abutting part 2132 may be relatively large and contact area between the abutting part 2132 and the locking member 2 may be increased, thereby ensuring the stability and reliability of the transmission connection between the abutting part 2132 and the locking member 2, and further improving the rotation stability of the locking member 2 caused by the abutting part 2132.

In addition, the implementation manner of transmission connection between the abutting part 2132 and the lock member 2 is not restricted, and may be chosen by those skilled in the art according to various application scenarios. For example, the abutting part 2132 may be securely coupled to the locking member 2 through a connector, and the connector may include a screw, a bolt, a stud, an adhesive, etc. In order to ensure the stability and reliability of the coupling between the abutting part 2132 and the locking member 2, in some embodiments, the locking member 2 may include a protrusion 218, and a recessed portion corresponding to the protrusion 218 may be formed at the abutting part 2132. When the abutting part 2132 and the locking member 2 are in the transmission connection, the protrusion 218 may be accommodated in the recessed portion. A shape of the recessed portion may match a shape of the protrusion 218. For example, if the protrusion 218 includes a cylindrical structure, the recessed portion may also include a cylindrical structure. If the protrusion 218 includes a square or rectangular structure, the recessed portion may also include a square or rectangular structure.

In some embodiments, the coupling part 2131 may be coupled to the output end of the steering gear 211, and thus, the steering gear 211 can cause the coupling part 2131 to rotate. The abutting part 2132 may be securely attached to the coupling part 2131. Thus, the abutting part 2132 may rotate together with the rotation of the coupling part 2131. Further, the abutting part 2132 may be in transmission connection with the locking member 2. In some embodiments, the protrusion 218 at the locking member 2 may be arranged in the recessed portion to achieve the transmission connection between the abutting part 2132 and the locking member 2. Accordingly, as the rotating shaft 213 rotates under the driving of the steering gear 211, the abutting part 2132 may cause the locking member 2 to rotate. The rotation stability and reliability of the locking member 2 may be realized, and usage stability and reliability of the drop box may be ensured.

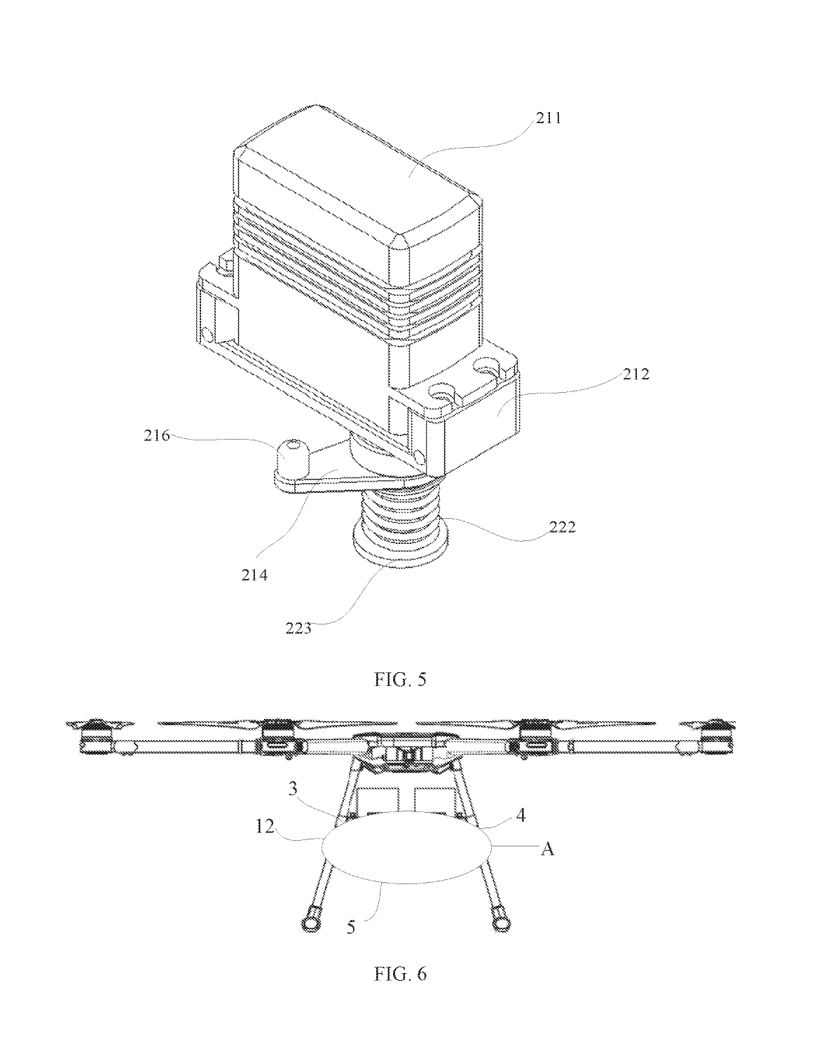

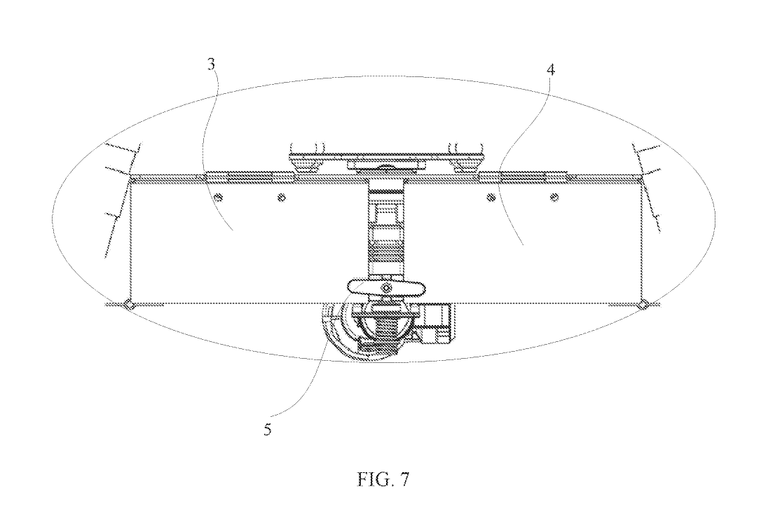

FIG. 6 is a schematic view showing an example operation status of an example drop box consistent with various disclosed embodiments of the present disclosure. FIG. 7 is an enlarged view of a portion A in FIG. 6 consistent with various disclosed embodiments of the present disclosure. Referring to FIGS. 1 to 6, in some embodiments, the at least two cabinets include a first cabinet 3 and a second cabinet 4. An installation space is arranged between the first cabinet 3 and the second cabinet 4. A driving member 21 is arranged in the installation space.

In some embodiments, the first cabinet 3 and the second cabinet 4 can include a same structure, and may be symmetrically arranged. The first cabinet 3 may include an accommodating space, and the second cabinet 4 may include another accommodating space, such that the drop box may include two accommodating spaces. Correspondingly, not only the number of objects to be dropped by the drop box can be ensured, but also the occupied space of the drop box can be reduced, thereby facilitating installation and use of the drop box.

In the present disclosure, the size of the installation space is not restricted, and may be chosen by those skilled in the art according to various application scenarios. The locking member 2 can contact with or separate from the bottom cabinet doors 11 of the at least two cabinets 1, so as to adjust the operation status of the locking member 2. In the embodiments that the first cabinet 3 and the second cabinet 4 are included, and the locking member 2 may be coupled to the driving member 21 for powering the locking member 2. In order to make it easier for the locking member 2 to adjust the operation statuses of the first cabinet 3 and the second cabinet 4, in some embodiments, the driving member 21 may further include a steering gear fixing seat 212, and the steering gear 211 may be arranged in the installation space through the steering gear fixing seat 212. A shape of the steering gear fixing seat 212 may match a shape of a contact end of the steering gear 211. The steering gear fixing seat 212 can ensure a stability performance of the steering gear 211, thereby improve operation stability and reliability of the steering gear 211, extending a service lifetime of the drop box, and increasing a market competitiveness of the drop box.

Referring to FIGS. 1 to 6, in some embodiments, the drop box further includes a reset member 22.

The reset member 22 is coupled to the guiding part 2133 and is used for providing an elastic restoring force to the locking member 2 to realize a reset operation on the locking member 2.

In the present disclosure, the shape and structure of the reset member 22 are not restricted. The reset member 22 may be configured by those skilled in the art according to the functions thereof. In some embodiments, the reset member 22 may include a cushion 221, a restoring spring 222, and an end cap 223 arranged sequentially along a direction away from the abutting part 2132.

The cushion 221 is arranged proximal to a lower end of the abutting part 2132. The restoring spring 222 is arranged as a sleeve at an outside of the guiding part 2133. The end cap 223 and the guiding part 2133 are screwed together. One end of the restoring spring 222 abuts against the cushion 221, and the other end of the restoring spring 222 abuts against the end cap 223 for providing an elastic restoring force to the locking member 2.

In some embodiments, when the coupling part 2131 causes the abutting part 2132 to rotate, the first sheet body 214 and the second sheet body 215 coupled to the abutting part 2132 may rotate together with the abutting part 2132, thereby achieving the switching of the operation status of the locking member 2. Correspondingly, the guiding part 2133 coupled to the abutting part 2132 may rotate together with the rotation of the abutting part 2132. The end cap 223 may be screwed together with the guiding part 2133, thereby causing the end cap 223 to rotate. The restoring spring 222 abutting the end cap 223 and the cushion 221 and arranged between the end cap 223 and the cushion 221 may be at a compressed status as the guiding part 2133 rotates. When the driving member stops driving the locking member 2 to rotate, the restoring spring 222 may provide an elastic restoring force to the locking member 2, thereby realizing the reset operation of the locking member 2, facilitating further adjustment of the operation status of the locking member 2 and ensuring convenient and fast use of the drop box.

Referring to FIGS. 1 to 6, in some embodiments, the cabinet 1 further includes a side cabinet door 12. Correspondingly, the drop box further includes a fastener 5.

The fastener 5 may be arranged at a side end of the at least two cabinet 1 for contacting with or separating from the at least two side cabinet doors 12, so as to open or close the accommodating spaces at the side of the cabinets 1.

To realize the contact with or separation from the at least two bottom cabinet doors 11 by the locking member 2, one end of the bottom cabinet door 11 may be hinged to the side cabinet door 12, such that one end of the bottom cabinet door 11 can be rotatably coupled to the side cabinet door 12. Accordingly, the locking member 2 can perform open or close operations of the accommodating spaces.

In addition, the shape and structure of the fastener 5 are not restricted, and may be chosen by those skilled in the art according to functions thereof. In some embodiments, the fastener 5 may have a same structure as the lock member 2. In some embodiments, the fastener 5 may include a rotary pin structure, a push rod structure, or the like, as long as the accommodating spaces can be opened or closed at the side of the cabinets 1, descriptions of which are omitted here.

In some embodiments, when objects need to be arranged in the drop box, the fastener 5 may be separated from the at least two side cabinet doors 12. Correspondingly, the accommodating spaces can be opened from the side of the cabinets 1 through the fastener 5, and the corresponding objects may be placed in the accommodating spaces. After the objects are placed, the accommodating spaces may be closed at the side of the cabinets 1 through the fastener 5. In some embodiments, the fastener 5 may be adjusted to contact the at least two side cabinet doors 12, thereby realizing stable placing of the objects in the accommodating spaces. Thus, the objects can be transferred or moved safely. In some embodiments, when the at least two bottom cabinet doors 11 are opened sequentially by adjusting the operation status of the locking member 2, correspondingly, the fastener 5 may be in contact with the at least two side cabinet doors 12. That is, the side cabinet doors 12 of the accommodating spaces may be ensured to be at a closed status.

Through the fastener 5, the accommodating spaces may be opened or closed at the side of the cabinets 1, such that it is relatively convenient to place needed objects into the drop box, further improving the convenience of using the drop box, ensuring the practicability of the drop box, and facilitating market promotions and applications.

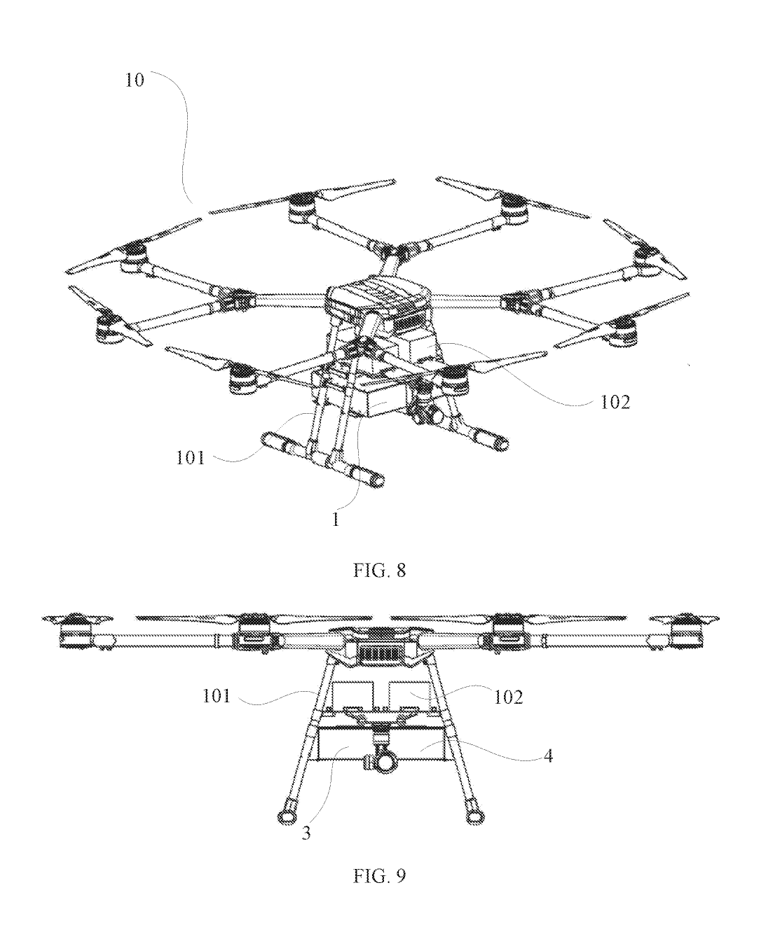

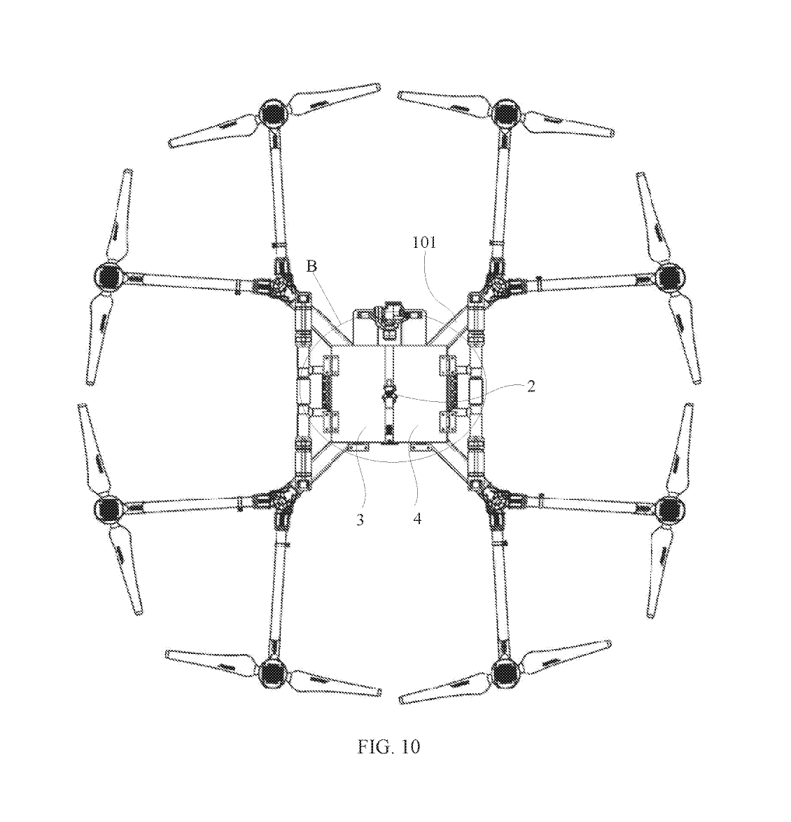

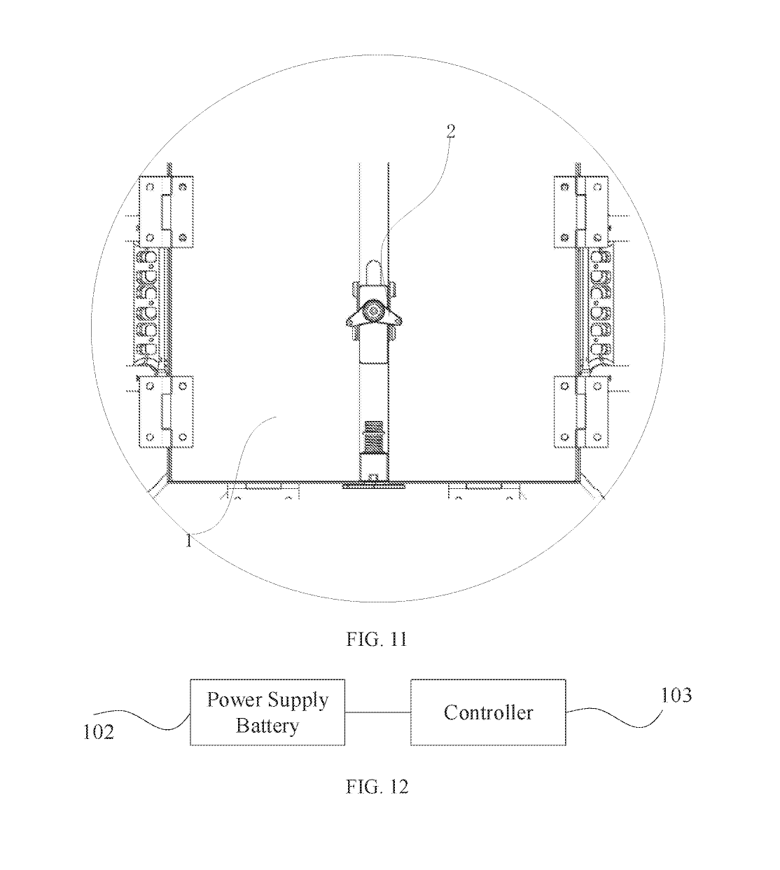

FIG. 8 is a schematic structural diagram of an example unmanned aerial vehicle 10 consistent with various disclosed embodiments of the present disclosure. FIG. 9 is another schematic structural diagram of the example unmanned aerial vehicle 10 consistent with various disclosed embodiments of the present disclosure. FIG. 10 is another schematic structural diagram of the example unmanned aerial vehicle 10 consistent with various disclosed embodiments of the present disclosure. FIG. 11 is an enlarged view of portion B in FIG. 10 consistent with various disclosed embodiments of the present disclosure. FIG. 12 is a block diagram of an electronic control of the example unmanned aerial vehicle 10 consistent with various disclosed embodiments of the present disclosure. As shown in FIGS. 8 to 12, the unmanned aerial vehicle (UAV) 10 includes a fuselage 101, and a controller 103 arranged at the fuselage 101.

A drop box of any one of the above-described examples may be attached to the fuselage 101 and coupled to the controller 103, for dropping objects under control of the controller 103.

In the present disclosure, the location where the drop box is attached to the fuselage 101 is not restricted, and may be chosen by those skilled in the art according to various application scenarios. For example, the drop box may be attached to the fuselage 101 above or next to a gimbal, etc. In some embodiments, a power supply battery 102 may be provided at the UAV 10. In some embodiments, the power supply battery 102 may be coupled to the controller 103 for providing electrical power to the controller 103. Correspondingly, the drop box may be arranged at a lower end of the power supply battery 102, e.g., below the power supply battery 102. Those skilled in the art can also arrange the drop box at other locations of the fuselage 101, descriptions of which are omitted here.

The structures, operation processes, and performances of the drop box in these embodiments are same as or similar to the drop boxes of the above-described examples. References can be made to the above-described examples, descriptions of which are not repeated here.

Through the drop box, the UAV 10 of present disclosure not only may ensure the number of objects accommodated in the drop box for a transfer operation of the objects, but also may adjust the operation status of the locking member 2 to open at least two bottom cabinet doors 11 sequentially, thereby realizing the dropping of the objects in the accommodating spaces in sequence. Accordingly, timely and effective delivery of the objects to corresponding locations may be achieved, quality and efficiency of first aid may be ensured, and thus the practicability of the UAV 10 may be improved, which improves market promotions and applications.

The present disclosure provides a drop box and a UAV. The drop box may include at least two cabinets. The at least two cabinets may include accommodating spaces therein, and bottom cabinet doors at bottoms of the accommodating spaces. The drop box may further include a locking member arranged at bottom ends of the at least two cabinets for contacting with or separating from the at least two bottom cabinet doors. By adjusting an operation status of the locking member, the at least two bottom cabinet doors may be opened sequentially. When the locking member is at a first operation status, the locking member may be in contact with the at least two bottom cabinet doors, and the accommodating spaces above the at least two bottom cabinet doors may be at a closed status. When the locking member is at a second operation status, the locking member may be separated from one bottom cabinet door, and the accommodating space above the bottom cabinet door may be at an open status. When the locking member is at a third operation status, the locking member may be separated from the at least two bottom cabinet doors, and the accommodating spaces above the at least two bottom cabinet doors are at the open status.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A drop box comprising:
two cabinets each including an accommodating space and a bottom cabinet door below the accommodating space; and
a locking member arranged at a bottom end of the two cabinets and configured to be in:
a first operation status, in which the locking member contacts the bottom cabinet door of each of the two cabinets, such that the accommodating space of each of the two cabinets is a closed status;
a second operation status, in which the locking member contacts the bottom cabinet door of one of the two cabinets and is separated from the bottom cabinet door of another one of the two cabinets, such that the accommodating space of the other one of the two cabinets is in an open status; and
a third operation status, in which the locking member is separated from the bottom cabinet door of each of the two cabinets, such that the accommodating space of each of the two cabinets is in the open status.

2. The drop box according to claim 1, wherein the locking member is configured to move among three positions including:
a first position, at which the locking member is in the first operation status;
a second position, at which the locking member is in the second operation status; and
a third position, at which the locking member is in the third operation status.

3. The drop box according to claim 2, wherein the locking member is configured to rotate among the three positions.

4. The drop box according to claim 2, wherein the locking member includes a first sheet body and a second sheet body with a preset intersection angle between the first sheet body and the second sheet body.

5. The drop box according to claim 4, wherein:
the locking member further includes a first sliding member vertically arranged at one end of the first sheet body and a second sliding member vertically arranged at one end of the second sheet body; and
the bottom cabinet door of each of the two cabinets includes a limiting slot configured to allow one of the first sliding member and the second sliding member to slide when the locking member moves among the three positions.

6. The drop box according to claim 1, further comprising:
a driving member configured to drive the locking member to switch sequentially to the first operation status, the second operation status, and the third operation status.

7. The drop box according to claim 6, wherein the driving member includes:
a rotating shaft; and
a steering gear coupled to the rotation shaft and configured to drive the locking member to rotate through the rotating shaft.

8. The drop box according to claim 7, wherein the rotating shaft includes:
a coupling part coupled to an output end of the steering gear; and
an abutting part coupled to the locking member in a transmission connection, and configured to drive the locking member to rotate when the rotating shaft is driven by the steering gear to rotate.

9. The drop box according to claim 8, wherein:
the abutting part includes a recessed portion; and
the locking member includes a protrusion accommodated in the recessed portion.

10. The drop box according to claim 8,
wherein:
the coupling part is arranged at a top side of the abutting part; and
the rotating shaft further includes a guiding part coupled to the abutting part and arranged at a bottom side of the abutting part;
the drop box further comprising:
a reset member coupled to the guiding part and configured to provide an elastic restoring force to the locking member to reset the locking member.

11. The drop box according to claim 10, wherein:
the guiding part includes a cylindrical structure, and
an outer diameter of the guiding part is smaller than an outer diameter of the abutting part.

12. The drop box according to claim 8, wherein:
the coupling part includes a circular ring structure; and
the abutting part includes a sleeve over the coupling part.

13. The drop box according to claim 7, wherein:
an installation space is formed between the two cabinets; and
the driving member is arranged in the installation space.

14. The drop box according to claim 13, wherein:
the driving member includes a steering gear fixing seat; and
the steering gear is arranged in the installation space through the steering gear fixing seat.

15. The drop box according to claim 1, wherein:
wherein one of the two cabinets includes a side cabinet door at a side of the one of the two cabinets;
the drop box further comprising:
a fastener arranged at the side of the one of the two cabinets and configured to contact with or be separated from the side cabinet door.

16. An unmanned aerial vehicle (UAV) comprising:
a fuselage;
a controller arranged at the fuselage; and
a drop box attached to the fuselage and coupled to the controller, the drop box including:
two cabinets each including an accommodating space and a bottom cabinet door below the accommodating space; and
a locking member arranged at a bottom end of the two cabinets and configured to be in:
a first operation status, in which the locking member contacts the bottom cabinet door of each of the two cabinets, such that the accommodating space of each of the two cabinets is a closed status;
a second operation status, in which the locking member contacts the bottom cabinet door of one of the two cabinets and is separated from the bottom cabinet door of another one of the two cabinets, such that the accommodating space of the other one of the two cabinets is in an open status; and
a third operation status, in which the locking member is separated from the bottom cabinet door of each of the two cabinets, such that the accommodating space of each of the two cabinets is in the open status.

17. The UAV according to claim 16, wherein the locking member is configured to move among three positions including:
a first position, at which the locking member is in the first operation status;
a second position, at which the locking member is in the second operation status; and
a third position, at which the locking member is in the third operation status.

18. The UAV according to claim 16, wherein the drop box further includes a driving member configured to drive the locking member to switch sequentially to the first operation status, the second operation status, and the third operation status.

19. The UAV according to claim 16, wherein:
one of the two cabinets includes a side cabinet door at a side of the one of the two cabinets; and
the drop box further includes a fastener arranged at the side of the one of the two cabinets and configured to contact with or be separated from the side cabinet door.

20. The UAV according to claim 19, wherein one end of the bottom cabinet door of the one of the two cabinets is hinged to the side cabinet door.
